(19) United States
(12) Patent Application Publication
(10) Pub. No.: US 2026/0046757 A1
(43) Pub. Date: Feb. 12, 2026

(54) Method and Apparatus for Edge Applications

(71) Applicant: Telefonaktiebolaget LM Ericsson (publ), Stockholm (SE)

(72) Inventors: Fengpei Zhang, Guangdong Guangzhou (CN); Yun Zhang, Guangdong Guangzhou (CN)

(21) Appl. No.: 19/102,800

(22) PCT Filed: Jan. 3, 2023
(86) PCT No.: PCT/CN2023/070038

§ 371 Date: Feb. 10, 2025

(51) Int. Cl. H04W 48/18; H04L 67/10; H04L 67/51; H04W 48/16

(52) U.S. Cl. CPC H04W 48/18; H04L 67/10; H04L 67/51; H04W 48/16

(57) ABSTRACT

A method for edge applications is provided. The method which may be performed by a terminal device comprises: receiving first edge discovery information from a first network via a first communication module of the terminal device, and receiving second edge discovery information from a second network via a second communication module of the terminal device. The method further comprises: determining whether to select a common edge application server (EAS) or separate EASs for the first network and the second network to connect with the terminal device, based at least in part on the first edge discovery information and the second edge discovery information.

### FIELD OF THE INVENTION

The present disclosure generally relates to communication networks, and more specifically, to a method and apparatus for edge applications.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. In order to meet dramatically increasing communication requirements, one interesting option for networking technique development is to support edge computing. Edge computing as an evolution of cloud computing may bring applications hosting from centralized data centers down to the network edge, closer to consumers and the data generated by the applications, especially when latency and bandwidth efficiency are concerned.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

With the rapid development of data communication and equipment manufacturing technologies, various communication devices are designed and utilized to support diversified services. In recent years, a terminal device (e.g., a vehicle, a drone, etc.) is becoming more and more intelligent, and it can communicate with any other entity that can offer rich services to customers, such as multi-media experience, more safety experience, more smart navigation experience, etc. In order to guarantee stable service performance, network redundancy may be provided to a terminal device for some mission critical Internet of things (C-IoT) applications (e.g., autonomous driving, media production, etc.). In this case, a C-IoT device may be configured to connect with one application server in parallel through two networks owned by different operators. The network redundancy configuration of the C-IoT device may be easily implemented in a data network with a central application server (CAS). However, due to the distributed architecture of edge computing, it may be challenging for the C-IoT device to access to a proper edge application server (EAS) through redundant connections.

Various exemplary embodiments of the present disclosure propose a solution for edge applications, which can enable a C-IoT device to select proper EAS(s) to connect with, e.g., based on edge discovery information from two redundant networks.

According to a first aspect of the present disclosure, there is provided a method performed by a terminal device. The method comprises: receiving first edge discovery information from a first network via a first communication module of the terminal device, and receiving second edge discovery information from a second network via a second communication module of the terminal device. In accordance with an exemplary embodiment, the method further comprises: determining whether to select a common EAS or separate EASs for the first network and the second network to connect with the terminal device, based at least in part on the first edge discovery information and the second edge discovery information.

In accordance with an exemplary embodiment, the first communication module may provide a first identifier of the terminal device for the first network, and the second communication module may provide a second identifier of the terminal device for the second network.

In accordance with an exemplary embodiment, when the first edge discovery information and the second edge discovery information indicate different EASs, the terminal device may determine to select the separate EASs for the first network and the second network to connect with the terminal device.

In accordance with an exemplary embodiment, the separate EASs for the first network and the second network may include a first EAS for the first network and a second EAS for the second network.

In accordance with an exemplary embodiment, the method according to the first aspect of the present disclosure may further comprise: establishing a first connection between the first communication module of the terminal device and the first EAS via the first network.

In accordance with an exemplary embodiment, the method according to the first aspect of the present disclosure may further comprise: establishing a second connection between the second communication module of the terminal device and the second EAS via the second network.

In accordance with an exemplary embodiment, when the first edge discovery information and the second edge discovery information indicate a same EAS, the terminal device may determine to select the common EAS for the first network and the second network to connect with the terminal device.

In accordance with an exemplary embodiment, the method according to the first aspect of the present disclosure may further comprise: establishing a first connection between the first communication module of the terminal device and the common EAS via the first network.

In accordance with an exemplary embodiment, the method according to the first aspect of the present disclosure may further comprise: establishing a second connection between the second communication module of the terminal device and the common EAS via the second network.

In accordance with an exemplary embodiment, the method according to the first aspect of the present disclosure may further comprise: transmitting, to the common EAS, a message for subscribing a connection recommendation about which of the first connection and the second connection is a primary connection for the terminal device.

In accordance with an exemplary embodiment, the method according to the first aspect of the present disclosure may further comprise: receiving connection recommendation information from the common EAS. In an embodiment, the connection recommendation information may indicate a recommended primary connection for the terminal device by the common EAS.

In accordance with an exemplary embodiment, the connection recommendation information may be determined by the common EAS based at least in part on one or more of: cell load data of a serving area of the common EAS; location information of the terminal device; and one or more charging policies of the first network and/or the second network.

In accordance with an exemplary embodiment, the method according to the first aspect of the present disclosure may further comprise: determining which of the first connection and the second connection is a primary connection for the terminal device, according to connection recommendation information from the common EAS and/or local information of the terminal device.

In accordance with an exemplary embodiment, the local information of the terminal device may include at least signal strength information of the terminal device.

In accordance with an exemplary embodiment, the terminal device may be a C-IoT device.

According to a second aspect of the present disclosure, there is provided an apparatus which may be implemented as a terminal device. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided a method performed by an EAS. The method comprises: receiving, from a terminal device, a message for subscribing a connection recommendation about which of a first connection and a second connection is a primary connection for the terminal device. The first connection is between a first communication module of the terminal device and the EAS via a first network, and the second connection is between a second communication module of the terminal device and the EAS via a second network. In accordance with an exemplary embodiment, the method further comprises: determining connection recommendation information, in response to the message. The connection recommendation information indicates a recommended primary connection for the terminal device by the EAS.

In accordance with an exemplary embodiment, the connection recommendation information may be determined by the EAS based at least in part on one or more of: cell load data of a serving area of the EAS; location information of the terminal device; and one or more charging policies of the first network and/or the second network.

In accordance with an exemplary embodiment, the method according to the fourth aspect of the present disclosure may further comprise: transmitting the connection recommendation information to the terminal device.

According to a fifth aspect of the present disclosure, there is provided an apparatus which may be implemented as an EAS. The apparatus may comprise one or more processors and one or more memories storing computer program codes. The one or more memories and the computer program codes may be configured to, with the one or more processors, cause the apparatus at least to perform any step of the method according to the fourth aspect of the present disclosure.

According to a sixth aspect of the present disclosure, there is provided a computer-readable medium having computer program codes embodied thereon which, when executed on a computer, cause the computer to perform any step of the method according to the fourth aspect of the present disclosure.

According to a seventh aspect of the present disclosure, there is provided a method performed by a terminal device (e.g., a C-IoT device, etc.). The method comprises: detecting that a first connection between a first communication module of the terminal device and a first EAS via a first network is broken. In accordance with an exemplary embodiment, the method further comprises: determining to switch from the first connection to a second connection between a second communication module of the terminal device and a second EAS via a second network. In accordance with an exemplary embodiment, the method further comprises: triggering an application context relocation (ACR) procedure for transferring application context of the terminal device from the first EAS to the second EAS.

In accordance with an exemplary embodiment, the first connection may be a primary connection for an edge service of the terminal device, and the second connection may be a secondary connection for the edge service of the terminal device.

In accordance with an exemplary embodiment, in the ACR procedure, the application context of the terminal device may be pulled from the first EAS to the second EAS.

In accordance with an exemplary embodiment, the method according to the seventh aspect of the present disclosure may further comprise: starting using the second connection when the ACR procedure is completed.

According to an eighth aspect of the present disclosure, there is provided an apparatus which may be implemented as a terminal device. The apparatus may comprise one or more processors and one or more memories storing computer program codes. The one or more memories and the computer program codes may be configured to, with the one or more processors, cause the apparatus at least to perform any step of the method according to the seventh aspect of the present disclosure.

According to a ninth aspect of the present disclosure, there is provided a computer-readable medium having computer program codes embodied thereon which, when executed on a computer, cause the computer to perform any step of the method according to the seventh aspect of the present disclosure.

According to various exemplary embodiments, a terminal device (e.g., a C-IoT device, etc.) may anchor to a common EAS or separate EASs for redundant networks, so as to access to edge applications through redundant connections from different operators. In addition, the terminal device may trigger a ACR procedure in case of a connection failure, ensuring the service continuity of the terminal device.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1A is a diagram illustrating an example of network redundancy according to an embodiment of the present disclosure;

FIG. 1B is a diagram illustrating an exemplary architecture for enabling edge applications according to an embodiment of the present disclosure;

FIG. 1C is a diagram illustrating a Global System for Mobile communications Association (GSMA) operator platform (OP) reference architecture according to an embodiment of the present disclosure;

FIG. 1D is a diagram illustrating exemplary GSMA OP to 3GPP EDGEAPP mapping according to an embodiment of the present disclosure;

FIGS. 2A-2B are diagrams illustrating examples of network redundancy according to some embodiments of the present disclosure;

FIGS. 2C-2D are diagram illustrating exemplary edge system architectures supporting network redundancy according to some embodiments of the present disclosure;

FIG. 3A is a diagram illustrating an exemplary edge discovery and selection procedure according to an embodiment of the present disclosure;

FIG. 3B is a flowchart illustrating an EAS discovery and selection procedure according to an embodiment of the present disclosure;

FIG. 3C is a diagram illustrating an exemplary operator/connection recommendation procedure according to an embodiment of the present disclosure;

FIG. 3D is a flowchart illustrating a primary operator/connection recommendation procedure according to an embodiment of the present disclosure;

FIG. 3E is a diagram illustrating an exemplary connection failover procedure according to an embodiment of the present disclosure;

FIG. 3F is a flowchart illustrating a connection failover procedure according to an embodiment of the present disclosure;

FIGS. 4A-4B are flowcharts illustrating methods according to some embodiments of the present disclosure;

FIG. 5 is a flowchart illustrating a method according to an embodiment of the present disclosure; and

FIG. 6 is a block diagram illustrating an apparatus according to an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Since a single network may not guarantee stable low latency (even though 5G era comes) due to the coverage, signal strength, capacity and even network incidents, it may be attractive to apply network redundancy to ensure system performance and meet quality of service (QoS) requirements. System/network redundancy may be important for some mission critical IoT (C-IoT) applications, for example, autonomous driving vehicles to ensure driving safety, media production equipment to ensure service continuity, etc.

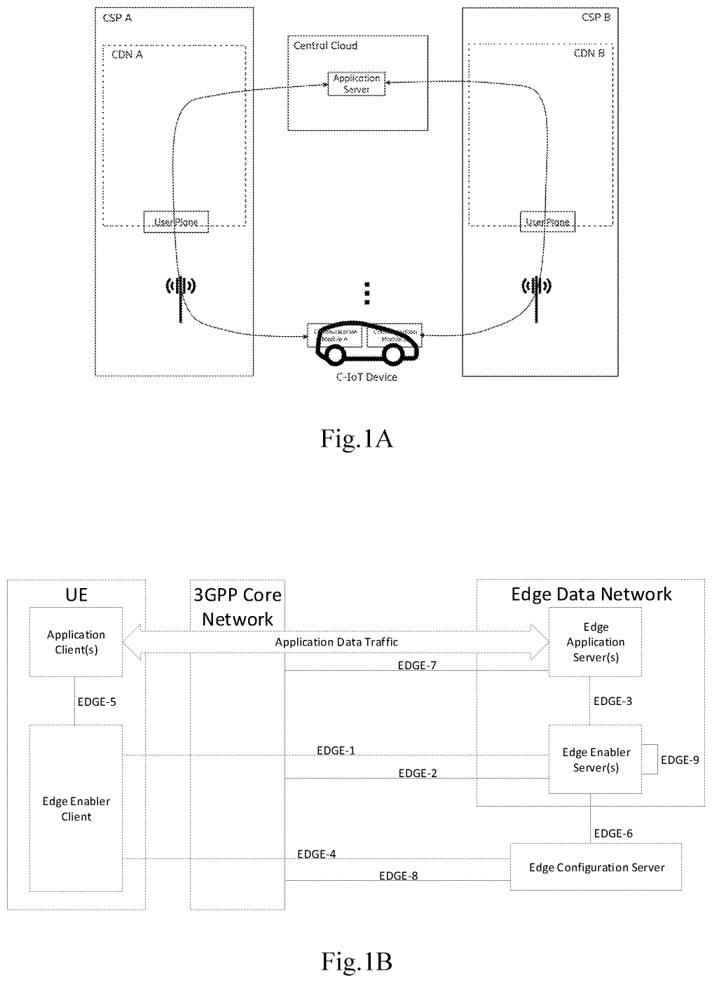

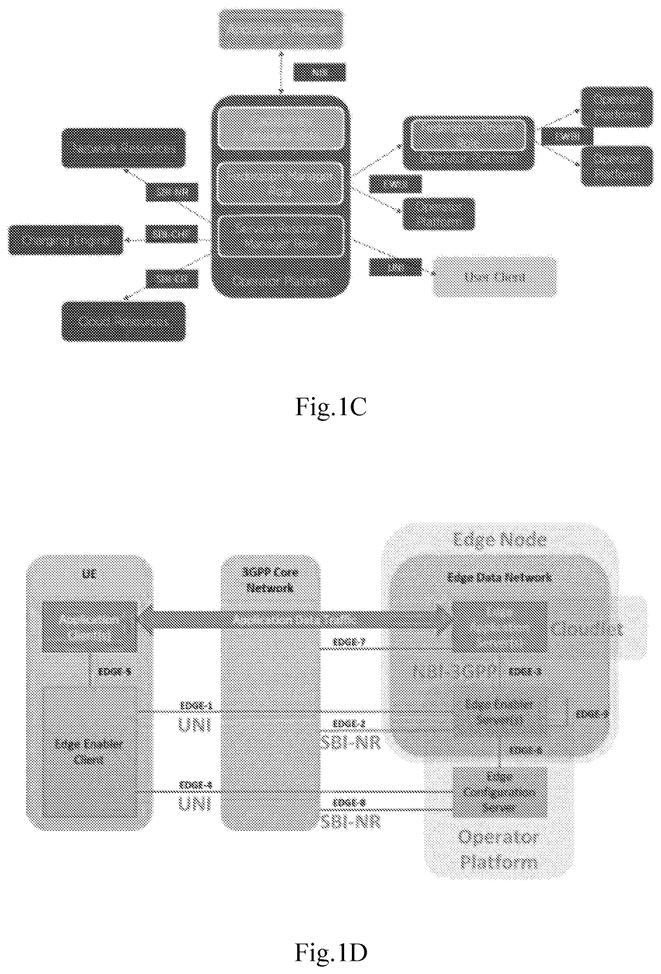

FIG. 1A is a diagram illustrating an example of network redundancy according to an embodiment of the present disclosure. As shown in FIG. 1A, when the network redundancy is applied for a C-IoT device in central data networks (CDNs), the C-IoT device may be equipped with two communication modules (i.e., communication module A and communication module B shown in FIG. 1A) connecting with the same application server through different mobile networks (i.e., CDN A and CDN B shown in FIG. 1A) provided by two telecommunication operators in parallel.

Edge computing may play an important role in the transformation of the telecommunications business, where telecommunications networks are turning into versatile service platforms for industry and other specific customer segments. This transformation may be supported by edge computing, as it opens the network edge for applications and services, including those from third parties.

Due to the distributed architecture of edge computing, the edge discovery service may be critical for UEs to access the applications deployed in edges. The edge discovery service may take into account the context of a user equipment (UE), such as location, Internet protocol (IP) anchor location, current network traffic, and other factors to determine which edge or edge application server a UE may need to connect to.

Mobility is the nature of UEs. When a UE moves within a mobile communication network, the mobile edge serving to the UE may be changed. Switching mobile edge, which may include application relocation and application context transfer (ACR) may be important to ensure service continuity.

In Release 17, the 3rd generation partnership project (3GPP) aims to provide native support of edge computing in 3GPP networks. These efforts may include initiatives across several working groups in 3GPP including SA6, SA2, SA3, SA4 and SA5, which cover application layer architecture, core network enhancement, security, media processing, and management aspects, respectively.

FIG. 1B is a diagram illustrating an exemplary architecture for enabling edge applications according to an embodiment of the present disclosure. As described in 3GPP Technical Specification (TS) 23.558 V17.5.0, SA6 initiated normative specification work on the architecture for enabling edge applications (EDGEAPP). The objective of the work is to define an enabling layer to facilitate communication between the application clients (AC) running on the UE and the edge application servers (EAS) deployed on the edge data network. This may include aspects of service provisioning and EAS discovery. In addition, the work aims to provide support services such as application context transfer between EASs for service continuity, service enablement and capability exposure application programming interfaces (APIs) towards the EAS.

Global System for Mobile communications Association (GSMA) Operator Platform defines a common platform exposing operator services/capabilities to customers/developers in the 5G-era in a connect once, connect to many models, as described in GSMA Operator Platform Telco Edge Requirements, Version 2.0. The first phase of the platform focuses on edge which may be expanded in future phases with other capabilities such as connectivity and slicing.

FIG. 1C is a diagram illustrating a GSMA OP reference architecture according to an embodiment of the present disclosure. As shown in FIG. 1C, the Federation Broker and Manager roles in the OP may be responsible for interfacing with other OPs via the East-West Bound Interface. Typical scenarios enabled by the Federation Manager role may be:
Federation Interconnection Management;
Edge Cloud Resource Exposure and Monitoring towards partner OPs;
Application Images and Application metadata transfer towards partner OPs;
Application Instantiation/Termination towards partner OPs;
Application Monitoring towards partner OPs; and
Service Availability in visited networks.

The Federation Broker may be an optional role. It may act as a broker to simplify the federation management between multiple OPs.

FIG. 1D is a diagram illustrating exemplary GSMA OP to 3GPP EDGEAPP mapping according to an embodiment of the present disclosure. In terms of the relationship between GSMA OP and 3GPP EDGEAP, the edge enabler server (EES) (and edge configuration server (ECS)) may map to the Capability Exposure, Service Resource Manager and Federation Manager as defined on OP, except for cloud resource management, as shown in FIG. 1D.

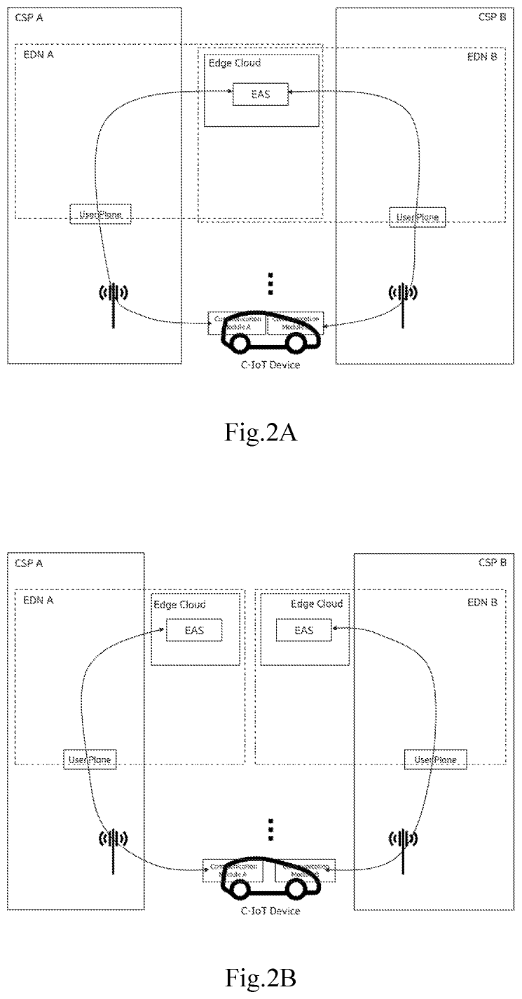

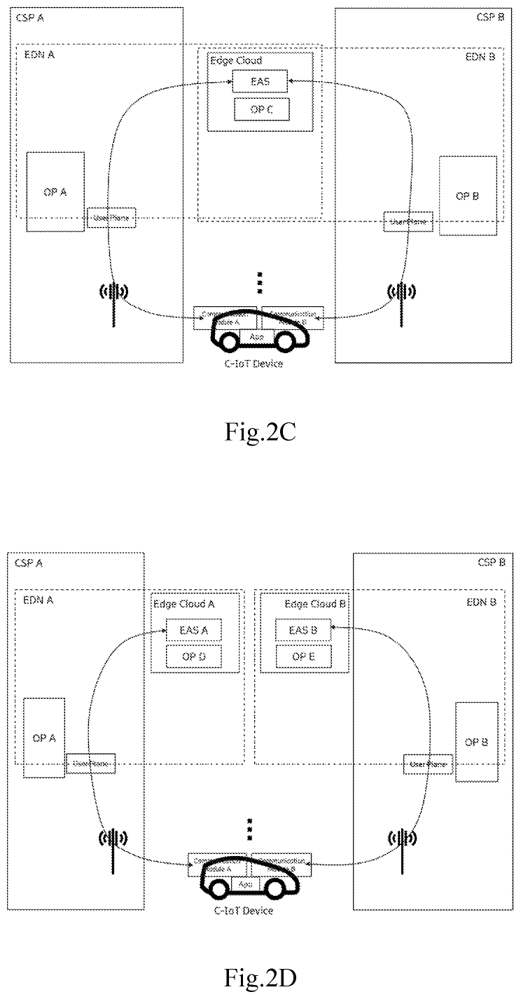

FIGS. 2A-2B are diagrams illustrating examples of network redundancy according to some embodiments of the present disclosure. As shown in FIGS. 2A-2B, the network redundancy may be applied for a C-IoT device equipped with two communication modules (i.e., communication module A and communication module B shown in FIGS. 2A-2B) in edge data networks (EDNs). Since the edge computing systems are distributed, when the C-IoT device is in a specific location, two connections (respectively through different mobile networks (e.g., EDN A and EDN B shown in FIGS. 2A-2B) provided by two operators) via the two communication modules in the C-IoT device may anchor to the same EAS as shown in FIG. 2A (e.g., if the edges provided by the two operators have overlapped serving areas), or may anchor to different EASs as shown in FIG. 2B (e.g., if the edges provided by the two operators have no overlapped serving areas).

It can be seen that the complexity of edge computing systems makes the network redundancy of C-IoT devices very different from the central data network. Currently, there is no feasible solution to address one or more above issues with respect to the network redundancy for C-IoT devices in edge data networks.

Various exemplary embodiments of the present disclosure propose a solution for edge applications, which may enable a C-IoT device to access to proper EAS(s) through redundant connections from different operators to ensure service continuity. In accordance with an exemplary embodiment, an application function may be introduced in the C-IoT device side to select the proper EAS(s) based on the edge discovery information from two redundant operators. In accordance with another exemplary embodiment, when the C-IoT device can anchor to the same EAS in a specific location, a mechanism may be applied in the EAS side to recommend a primary operator/connection to the C-IoT device based on cell load and/or other information. In accordance with a further exemplary embodiment, when the C-IoT device may not anchor to the same EAS in a specific location, an application function may be introduced in the C-IoT device side for connection failover.

Many advantages may be achieved by applying the proposed solutions. For example, the proposed solutions may enable C-IoT devices to access edges with network redundancy, while the existing solutions may only support C-IoT devices with network redundancy to access the central data network. In addition, the proposed solutions can improve the service continuity of mission C-IoT applications even when network outage happens in edge computing scenarios.

FIGS. 2C-2D are diagram illustrating exemplary edge system architectures supporting network redundancy according to some embodiments of the present disclosure. Specifically, FIG. 2C shows a scenario where a C-IoT device anchors to the same EAS through OP A of EDN A and OP B of EDN B, while FIG. 2D shows another scenario where a C-IoT device anchors to different EASs (i.e., EAS A and EAS B) through OP A of EDN A and OP B of EDN B. As shown in FIGS. 2C-2D, the edge system architecture supporting network redundancy may have the following main entities:
C-IoT Device: A critical IoT device with network redundancy may consist of an application and two communication modules connecting with two telecom operators in parallel.
Edge Data Network (EDN): A subarea of a public land mobile network (PLMN) through which a terminal device (e.g., a UE, etc.) can communicate with the EASs with the benefits of edge computing, such as low latency and high bandwidth.
Operator Platform (OP): GSMA OP defines a common platform exposing operator services/capabilities to customers/developers. As described in 3GPP TS 23.558 V17.5.0, in terms of edge computing, GSMA OP can be mapped to:
   Edge Enabler Server (EES) in 3GPP SA6 EDGEAPP, and
   Edge Configuration Server (ECS) in 3GPP SA6 EDGEAPP.
Edge Cloud: The cloud used for EAS hosting. The Edge Cloud may interconnect with one or more EDNs. The Edge Cloud may be shared across multiple telecom operators:
   Provided by a specific telecom operator and shareable; or
   Provided by a partner and shareable.
Edge Application Server (EAS): An application server developed by Application Service Provider (ASP) implementing specific business logic. EAS may be deployed on Edge Cloud and can be access through an EDN.

It can be appreciated that the system architecture and various entities shown in FIGS. 2C-2D are just examples, and more or less alternative entities and the corresponding interfaces may be included in the edge system architecture with different structures to support network redundancy according to embodiments of the present disclosure.

As mentioned previously, due to the potential edge computing topology different across operators, a C-IoT device with network redundancy may or may not be able to anchor to the same EAS in a specific location.

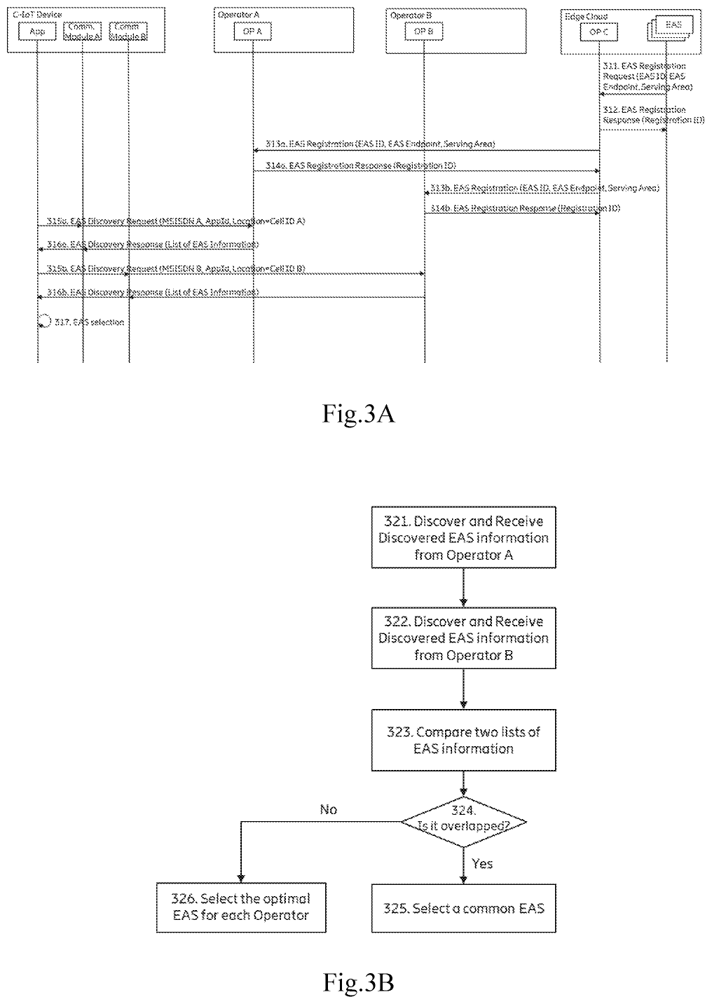

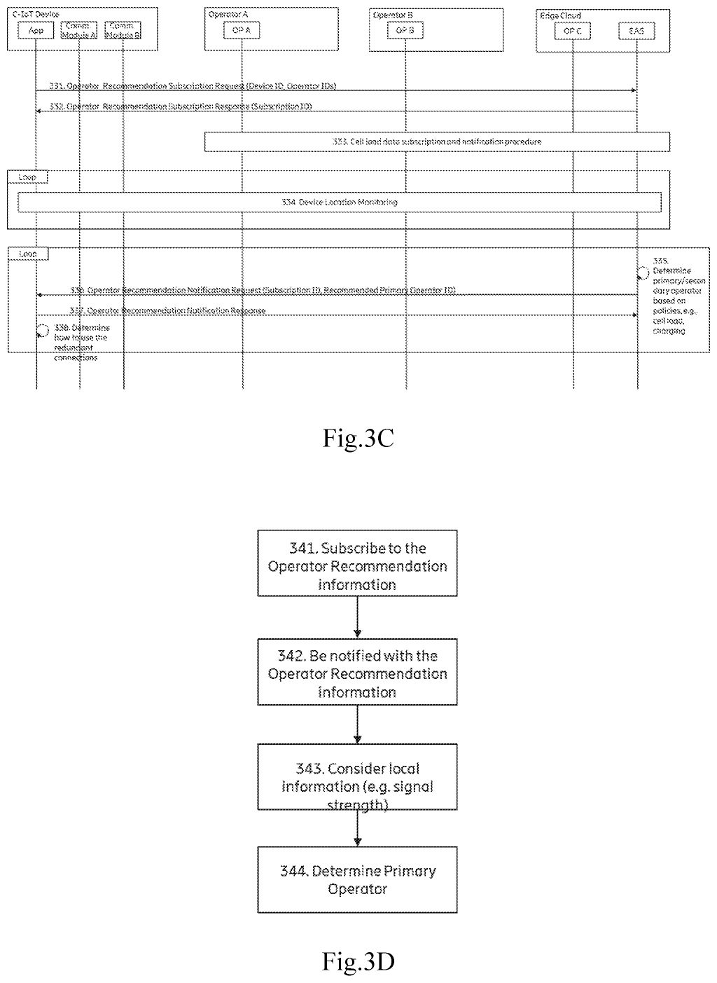

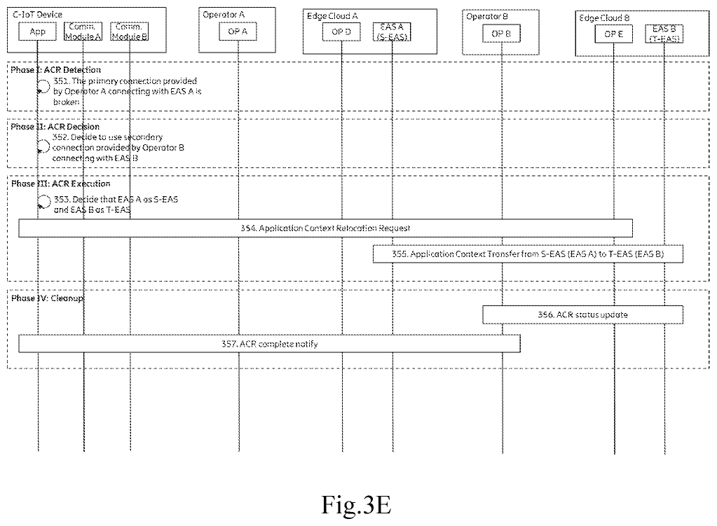

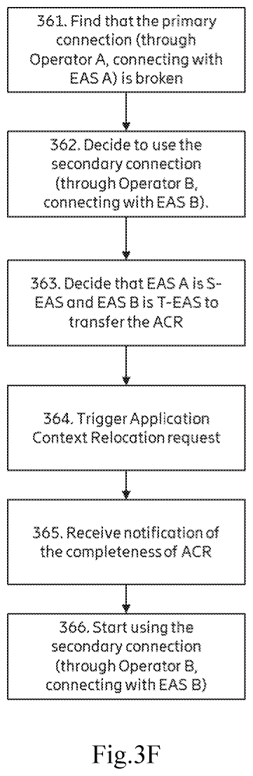

FIG. 3A is a diagram illustrating an exemplary edge discovery and selection procedure according to an embodiment of the present disclosure. The edge discovery and selection procedure may be performed for a C-IoT device with network redundancy to discover and select proper EAS(s). In accordance with an exemplary embodiment, the C-IoT device may prefer selecting a common EAS, and if not possible, may select one for each operator/connection. It can be appreciated that network elements and signaling messages shown in FIG. 3A are just examples, and more or less alternative network elements and signaling messages may be involved in the edge discovery and selection procedure according to various embodiments of the present disclosure. As shown in FIG. 3A, the edge discovery and selection procedure may include the following operations:
311: An EAS may send an ‘EAS Registration’ request to the Edge Cloud's OP C. The request may at least include:
   ‘EAS ID’ which is the identity of the EAS;
   ‘Endpoint’ indicating the endpoint information (e.g., uniform resource locator (URL), etc.) through which the device can access the EAS; and
   ‘Serving Area’ indicating the geographical area where the EAS can serve the device.
312 : The Edge Cloud's OP C may send an ‘EAS Registration’ response back to the EAS with a ‘Registration ID’ which is the identity of this registration.
313a: The Edge Cloud's OP C may send an ‘EAS Registration’ request to the Operator A's OP A. The request may at least include:
   ‘EAS ID’ Which Is the Identity of the EAS;
   ‘Endpoint’ indicating the endpoint information (e.g., URL, etc.) through which the device can access the EAS; and
   ‘Serving Area’ indicating the geographical area where the EAS can serve the device.
314a: The Operator A's OP A may send an ‘EAS Registration’ response back to the Edge Cloud's OP C with a ‘Registration ID’ which is the identity of this registration.
313b: The Edge Cloud's OP C may send an ‘EAS Registration’ request to the Operator B's OP B. The request may at least include:
   ‘EAS ID’ which is the identity of the EAS;
   ‘Endpoint’ indicating the endpoint information (e.g., URL, etc.) through which the device can access the EAS; and
   ‘Serving Area’ indicating the geographical area where the EAS can serve the device.
314b: The Operator B's OP B may send an ‘EAS Registration’ response back to the Edge Cloud's OP C with a ‘Registration ID’ which is the identity of this registration.
315a: The device application may send an ‘EAS Discovery’ request to the Operator A's OP A through communication module A. The request may at least include:
   ‘Mobile Station Integrated Services Digital Network Number (MSISDN) A’ which is from the communication module A;
   ‘App ID’ which is the identity of the device application; and
   ‘Location’ which is the location of the C-IoT device, e.g., Cell ID A.
316a: The Operator A's OP A may send an ‘EAS Discovery’ response back to the device application. The response may include a list of ‘EAS information’ which may at least contain:
   ‘EAS ID’ which is the identity of the EAS; and
   ‘Endpoint’ indicating the endpoint information (e.g., URL, etc.) through which the device application can access the EAS.
315b: The device application may send an ‘EAS Discovery’ request to the Operator B's OP B through communication module B. The request may at least include:
   ‘MSISDN B’ which is from the communication module B;
   ‘App ID’ which is the identity of the device application; and
   ‘Location’ which is the location of the C-IoT device, e.g., Cell ID B.
316b: The Operator B's OP B may send an ‘EAS Discovery’ response back to the device application. The response may include a list of ‘EAS information’ which may at least contain:
   ‘EAS ID’ which is the identity of the EAS; and
   ‘Endpoint’ indicating the endpoint information (e.g., URL, etc.) through which the device application can access the EAS.
317: The device application may use the discovered EAS information from both operators to determine the selected EAS(s).

FIG. 3B is a flowchart illustrating an EAS discovery and selection procedure according to an embodiment of the present disclosure. The EAS discovery and selection procedure may be implemented at the C-IoT device side, e.g., by means of the device application as described with respect to FIG. 3A. As shown in FIG. 3B, the C-IoT device may request and receive discovered EAS information from Operator A in step 321, and request and receive discovered EAS information from Operator B in step 322. Then in step 323, the C-IoT device may compare two lists of EAS information from Operator A and Operator B. If the two lists are overlapped (i.e., “Yes” branch in step 324), then in step 325, the C-IoT device may select a common EAS for both two connections to connect with. If the two lists are not overlapped (i.e., “No” branch in step 324), then in step 326, the C-IoT device may select an optimal EAS for each Operator and connect with the Operator specific connection.

FIG. 3C is a diagram illustrating an exemplary operator/connection recommendation procedure according to an embodiment of the present disclosure. The operator/connection recommendation procedure may be applicable to the scenario that a C-IoT device is anchoring to the common EAS. Once the C-IOT device is able to anchor to the common EAS through both connections, the common EAS may recommend the primary operator/connection by using the network information. It can be appreciated that network elements and signaling messages shown in FIG. 3C are just examples, and more or less alternative network elements and signaling messages may be involved in the operator/connection recommendation procedure according to various embodiments of the present disclosure. As shown in FIG. 3C, the operator/connection recommendation procedure may include the following operations:
331: The device application may send a ‘Operator Recommendation Subscription’request to the common EAS. The request may at least include:
   ‘Device ID’ which is the identity of the C-IoT device;
   ‘Operator IDs’ indicating the operators that the C-IoT device connects through, in this example, including Operator A ID and Operator B ID.
331: The common EAS may send an ‘Operator Recommendation Subscription’ response back to the device application with a ‘Subscription ID’ which is the identity of this subscription.
333: The common EAS may subscribe to the cell load data of its serving area through the Edge Cloud's OP C. Further, the Edge Cloud's OP C may forward the subscription to the Operator A's OP A and Operator B's OP B. The cell load data from the two Operators may be aggregated by the Edge Cloud's OP C and notified to the common EAS periodically.
334: The common EAS may trigger a location monitoring procedure for the device application. The procedure may use different alternative approaches:
   Using the location information (e.g., global positioning system (GPS) location, etc.) reported by the device application through user plane.
   Using the network location capabilities provided by the Operators.
335: Using the cell load data, the current location(s) of the device application, and/or other information (e.g., the charging policies from the Operators, etc.), the common EAS may determine the primary operator recommendation for the C-IoT device.
336: The common EAS may send an ‘Operator Recommendation Notification’ request to the device application. The request may at least include Subscription ID and the Recommended Primary Operator ID.
337: The device application may send an ‘Operator Recommendation Notification’response back to the common EAS.
338: By receiving the operator recommendation information from the common EAS, the device application may finally determine the primary operator together with other local information (e.g., the signal strength, etc.).

FIG. 3D is a flowchart illustrating a primary operator/connection recommendation procedure according to an embodiment of the present disclosure. The primary operator/connection recommendation procedure may be implemented at the C-IoT device side, e.g., by means of the device application as described with respect to FIG. 3C. As shown in FIG. 3D, the C-IoT device may subscribe to the operator recommendation information in step 341 and be notified with the operator recommendation information in step 342. Optionally, the C-IoT device may consider local information (e.g., the signal strength, etc.) in step 343, in addition or alternative to the operator recommendation information. In an embodiment, the C-IoT device may determine the primary operator/connection in step 344, based on the operator recommendation information and/or the local information.

For the case that the C-IoT device is anchoring to the common EAS through both connections, no ACR may be needed during connection switch. However, for the case that the C-IoT device is anchoring to different EASs through the redundant connections, an ACR procedure may be needed during connection switch.

FIG. 3E is a diagram illustrating an exemplary connection failover procedure according to an embodiment of the present disclosure. The connection failover procedure may be applicable to the scenario that a C-IoT device anchors to different EASs. In accordance with an exemplary embodiment, when the C-IOT device finds that the primary connection broken, it may trigger the connection failover procedure to switch to another connection. In a distributed edge computing system, ACR may be required before connection switching. It can be appreciated that network elements and signaling messages shown in FIG. 3E are just examples, and more or less alternative network elements and signaling messages may be involved in the connection failover procedure according to various embodiments of the present disclosure. As shown in FIG. 3E, the connection failover procedure may include the following operations:
351: The device application figures out that the primary connection through Operator A (assumed that Operator A is selected as the primary Operator at this moment) is broken. The primary connection is used to connect with EAS A.
352: The device application may decide to switch to the secondary connection through Operator B. The secondary connection is used to connect with EAS B. However, since the device application sends application data to EAS A, EAS B may be lack of application context to serve the C-IoT device application.
353: The device application may decide that EAS A may be the source EAS (S-EAS), EAS B may be the target EAS (T-EAS), and EAS B may pull the application context from EAS A.
354: The device application may trigger the Application Context Relocation Request to the Operator B's OP B through communication module B. Further, the Operator B's OP B may forward the request to the Edge Cloud B's OP E associated with EAS B (T-EAS). Edge Cloud B's OP E may facilitate the ACR between EAS B (T-EAS) and EAS A (S-EAS).
355: The application context may be transferred between EAS B (T-EAS) and EAS A (S-EAS). In this case, EAS B (T-EAS) may pull the application context from EAS A (S-EAS).
356: when the ACR is completed, EAS B (T-EAS) may notify the Edge Cloud B.
357: The device application may be notified with the completeness of the ACR so that it can switch to the connection provided by the Operator B.

FIG. 3F is a flowchart illustrating a connection failover procedure according to an embodiment of the present disclosure. The connection failover procedure may be implemented at the C-IoT device side, e.g., by means of the device application as described with respect to FIG. 3E. As shown in FIG. 3F, the C-IoT device may find that the primary connection (through Operator A, connecting with EAS A) is broken in step 361 and decide to use the secondary connection (through Operator B, connecting with EAS B) in step 362. The C-IoT device may decide to trigger ACR in step 363, where EAS A may be the S-EAS and EAS B may be the T-EAS. In this case, an ACR procedure may be triggered by the C-IoT device in step 364. When the ACR procedure is completed, the C-IoT device may receive a notification of the completeness of ACR in step 365. Then the C-IoT device may start using the secondary connection (through Operator B, connecting with EAS B) in step 366.

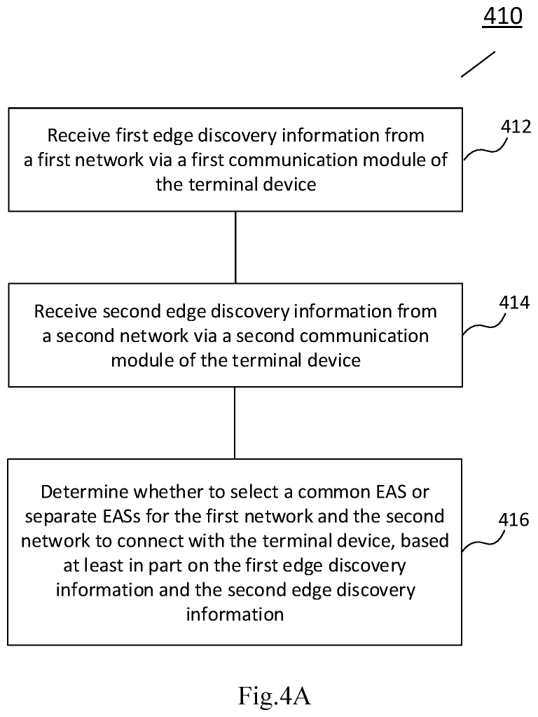

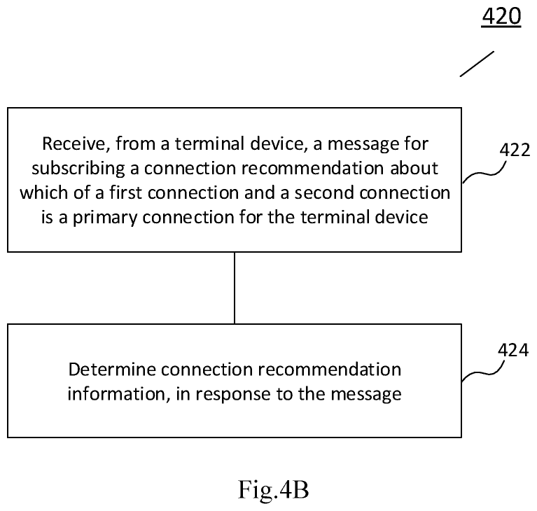

FIG. 4A is a flowchart illustrating a method 410 according to an embodiment of the present disclosure. The method 410 illustrated in FIG. 4A may be performed by a terminal device (e.g., a C-IoT device, etc.) or an apparatus communicatively coupled to the terminal device. In accordance with an exemplary embodiment, the terminal device may be configured to obtain various services provided by an application server (e.g., an EAS, a CAS, etc.) and communicate with other devices (e.g., another terminal device, a network node, etc.) in an edge computing system.

According to the exemplary method 410 illustrated in FIG. 4A, the terminal device may receive first edge discovery information from a first network via a first communication module of the terminal device, as shown in block 412. Similarly, the terminal device may receive second edge discovery information from a second network via a second communication module of the terminal device, as shown in block 414. In accordance with an exemplary embodiment, the terminal device may determine whether to select a common EAS or separate EASs for the first network and the second network to connect with the terminal device, based at least in part on the first edge discovery information and the second edge discovery information, as shown in block 416.

In accordance with an exemplary embodiment, the first communication module may provide a first identifier (e.g., ‘MSISDN A’ as described with respect to FIG. 3A, etc.) of the terminal device for the first network, and the second communication module may provide a second identifier (e.g., ‘MSISDN B’ as described with respect to FIG. 3A, etc.) of the terminal device for the second network.

In accordance with an exemplary embodiment, when the first edge discovery information and the second edge discovery information indicate different EASs, the terminal device may determine to select the separate EASs for the first network and the second network to connect with the terminal device. In an embodiment, the separate EASs for the first network and the second network may include a first EAS for the first network and a second EAS for the second network.

In accordance with an exemplary embodiment, the terminal device may establish a first connection between the first communication module of the terminal device and the first EAS via the first network, and establish a second connection between the second communication module of the terminal device and the second EAS via the second network.

In accordance with an exemplary embodiment, when the first edge discovery information and the second edge discovery information indicate a same EAS, the terminal device may determine to select the common EAS for the first network and the second network to connect with the terminal device.

In accordance with an exemplary embodiment, the terminal device may establish a first connection between the first communication module of the terminal device and the common EAS via the first network, and establish a second connection between the second communication module of the terminal device and the common EAS via the second network.

In accordance with an exemplary embodiment, the terminal device may transmit, to the common EAS, a message for subscribing a connection recommendation about which of the first connection and the second connection is a primary connection for the terminal device.

In accordance with an exemplary embodiment, the terminal device may receive connection recommendation information from the common EAS. In an embodiment, the connection recommendation information may indicate a recommended primary connection for the terminal device by the common EAS.

In accordance with an exemplary embodiment, the connection recommendation information may be determined by the common EAS based at least in part on one or more of: cell load data of a serving area of the common EAS; location information of the terminal device; and one or more charging policies of the first network and/or the second network.

In accordance with an exemplary embodiment, the terminal device may determine which of the first connection and the second connection is a primary connection for the terminal device, according to connection recommendation information from the common EAS and/or local information of the terminal device. In an embodiment, the local information of the terminal device may include at least signal strength information of the terminal device.

FIG. 4B is a flowchart illustrating a method 420 according to an embodiment of the present disclosure. The method 420 illustrated in FIG. 4B may be performed by an EAS or an apparatus communicatively coupled to the EAS. In accordance with an exemplary embodiment, the EAS may be configured to support or provision various services to one or more terminal devices. In accordance with another exemplary embodiment, the EAS may be configured to communicate with one or more other servers (e.g., one or more other EASs, a CAS, etc.) to implement application provision and/or management of one or more terminal devices.

According to the exemplary method 420 illustrated in FIG. 4B, the EAS may receive, from a terminal device (e.g., the terminal device as described with respect to FIG. 4A), a message for subscribing a connection recommendation about which of a first connection and a second connection is a primary connection for the terminal device, as shown in block 422. The first connection is between a first communication module of the terminal device and the EAS via a first network, and the second connection is between a second communication module of the terminal device and the EAS via a second network. In response to the message, the EAS may determine connection recommendation information, as shown in block 424. The connection recommendation information may indicate a recommended primary connection for the terminal device by the EAS. In an embodiment, the EAS may transmit the connection recommendation information to the terminal device.

In accordance with an exemplary embodiment, the connection recommendation information may be determined by the EAS based at least in part on one or more of: cell load data of a serving area of the EAS; location information of the terminal device; and one or more charging policies of the first network and/or the second network.

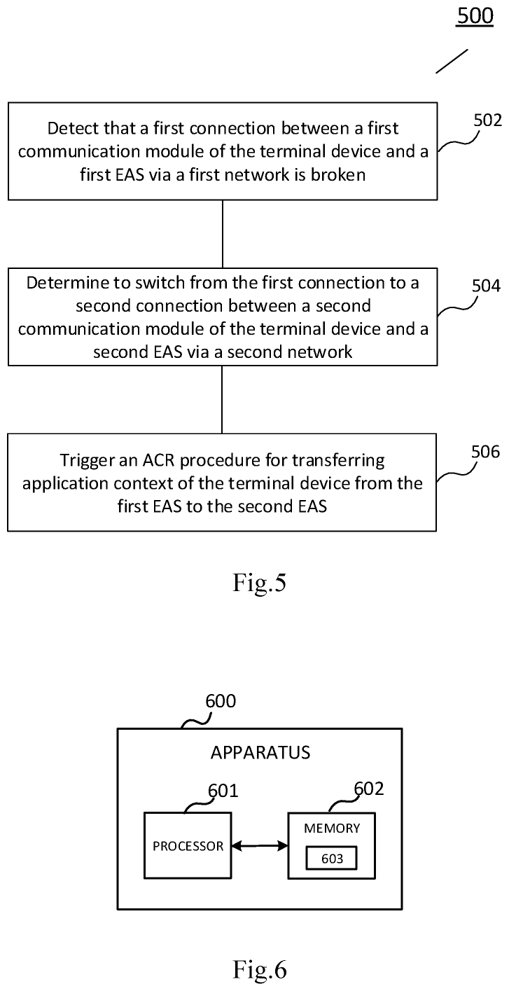

FIG. 5 is a flowchart illustrating a method 500 according to an embodiment of the present disclosure. The method 500 illustrated in FIG. 5 may be performed by a terminal device (e.g., a C-IoT device, etc.) or an apparatus communicatively coupled to the terminal device. In accordance with an exemplary embodiment, the terminal device may be configured to obtain various services provided by an application server (e.g., an EAS, a CAS, etc.) and communicate with other devices (e.g., another terminal device, a network node, etc.) in an edge computing system.

According to the exemplary method 500 illustrated in FIG. 5, the terminal device may detect that a first connection between a first communication module of the terminal device and a first EAS via a first network is broken, as shown in block 502. In this case, the terminal device may determine to switch from the first connection to a second connection between a second communication module of the terminal device and a second EAS via a second network, as shown in block 504. As described with respect to FIG. 4A, the first communication module may provide a first identifier of the terminal device for the first network, and the second communication module may provide a second identifier of the terminal device for the second network. In an embodiment, the first connection may be a primary connection for an edge service of the terminal device, and the second connection may be a secondary connection for the edge service of the terminal device.

In accordance with an exemplary embodiment, the terminal device may trigger an ACR procedure for transferring application context of the terminal device from the first EAS to the second EAS, as shown in block 506. According to an embodiment, in the ACR procedure, the application context of the terminal device may be pulled from the first EAS to the second EAS. When the ACR procedure is completed, the terminal device may start using the second connection.

The various blocks shown in FIG. 4A, FIG. 4B and FIG. 5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a terminal device as described with respect to FIG. 4A, or an EAS as described with respect to FIG. 4B, or a terminal device as described with respect to FIG. 5. In such cases, the apparatus 600 may be implemented as a terminal device as described with respect to FIG. 4A, or an EAS as described with respect to FIG. 4B, or a terminal device as described with respect to FIG. 5.

In some implementations, the one or more memories 602 and the computer program codes 603 may be configured to, with the one or more processors 601, cause the apparatus 600 at least to perform any operation of the method as described in connection with FIG. 4A. In other implementations, the one or more memories 602 and the computer program codes 603 may be configured to, with the one or more processors 601, cause the apparatus 600 at least to perform any operation of the method as described in connection with FIG. 4B. In other implementations, the one or more memories 602 and the computer program codes 603 may be configured to, with the one or more processors 601, cause the apparatus 600 at least to perform any operation of the method as described in connection with FIG. 5. Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. -31. (canceled)

32. A method performed by a terminal device, comprising:
receiving first edge discovery information from a first network via a first communication module of the terminal device;
receiving second edge discovery information from a second network via a second communication module of the terminal device; and
determining whether to select a common edge application server (EAS) or separate EASs for the first network and the second network to connect with the terminal device, based at least in part on the first edge discovery information and the second edge discovery information.

33. The method according to claim 32, wherein the first communication module provides a first identifier of the terminal device for the first network, and the second communication module provides a second identifier of the terminal device for the second network.

34. The method according to claim 32, wherein when the first edge discovery information and the second edge discovery information indicate different EASs, the terminal device determines to select the separate EASs for the first network and the second network to connect with the terminal device.

35. The method according to claim 34, wherein the separate EASs for the first network and the second network includes a first EAS for the first network and a second EAS for the second network, and the method further comprises:
establishing a first connection between the first communication module of the terminal device and the first EAS via the first network; and
establishing a second connection between the second communication module of the terminal device and the second EAS via the second network.

36. The method according to claim 32, wherein when the first edge discovery information and the second edge discovery information indicate a same EAS, the terminal device determines to select the common EAS for the first network and the second network to connect with the terminal device.

37. The method according to claim 36, further comprising:
establishing a first connection between the first communication module of the terminal device and the common EAS via the first network; and
establishing a second connection between the second communication module of the terminal device and the common EAS via the second network.

38. The method according to claim 37, further comprising transmitting, to the common EAS, a message for subscribing a connection recommendation about which of the first connection and the second connection is a primary connection for the terminal device.

39. The method according to claim 38, further comprising receiving connection recommendation information from the common EAS, wherein the connection recommendation information indicates a recommended primary connection for the terminal device by the common EAS.

40. The method according to claim 39, wherein the connection recommendation information is determined by the common EAS based at least in part on one or more of:
cell load data of a serving area of the common EAS;
location information of the terminal device; and
one or more charging policies of the first network and/or the second network.

41. The method according to claim 37, further comprising determining which of the first connection and the second connection is a primary connection for the terminal device, according to connection recommendation information from the common EAS and/or local information of the terminal device.

42. The method according to claim 41, wherein the local information of the terminal device includes at least signal strength information of the terminal device.

43. The method according to claim 32, wherein the terminal device is a critical Internet of things (IoT) device.

44. A terminal device, comprising:
one or more processors; and
one or more memories comprising computer program codes,
the one or more memories and the computer program codes configured to, with the one or more processors, cause the terminal device at least to:
receive first edge discovery information from a first network via a first communication module of the terminal device;
receive second edge discovery information from a second network via a second communication module of the terminal device; and
determine whether to select a common edge application server (EAS) or separate EASs for the first network and the second network to connect with the terminal device, based at least in part on the first edge discovery information and the second edge discovery information.

45. A method performed by an edge application server (EAS), comprising:
receiving, from a terminal device, a message for subscribing a connection recommendation about which of a first connection and a second connection is a primary connection for the terminal device, wherein the first connection is between a first communication module of the terminal device and the EAS via a first network, and the second connection is between a second communication module of the terminal device and the EAS via a second network; and
determining connection recommendation information, in response to the message, wherein the connection recommendation information indicates a recommended primary connection for the terminal device by the EAS.

46. The method according to claim 45, wherein the connection recommendation information is determined by the EAS based at least in part on one or more of:
cell load data of a serving area of the EAS;
location information of the terminal device; and
one or more charging policies of the first network and/or the second network.

47. The method according to claim 45, further comprising transmitting the connection recommendation information to the terminal device.

48. The method according to claim 45, wherein the first communication module provides a first identifier of the terminal device for the first network, and the second communication module provides a second identifier of the terminal device for the second network.

49. An edge application server (EAS), comprising:
one or more processors; and
one or more memories comprising computer program codes,
the one or more memories and the computer program codes configured to, with the one or more processors, cause the EAS at least to:
receive, from a terminal device, a message for subscribing a connection recommendation about which of a first connection and a second connection is a primary connection for the terminal device, wherein the first connection is between a first communication module of the terminal device and the EAS via a first network, and the second connection is between a second communication module of the terminal device and the EAS via a second network; and
determine connection recommendation information, in response to the message, wherein the connection recommendation information indicates a recommended primary connection for the terminal device by the EAS.

50. A method performed by a terminal device, comprising:
detecting that a first connection between a first communication module of the terminal device and a first edge application server (EAS) via a first network is broken;
determining to switch from the first connection to a second connection between a second communication module of the terminal device and a second EAS via a second network; and
triggering an application context relocation (ACR) procedure for transferring application context of the terminal device from the first EAS to the second EAS.

51. The method according to claim 50, wherein the first connection is a primary connection for an edge service of the terminal device, and the second connection is a secondary connection for the edge service of the terminal device.

52. The method according to claim 50, wherein in the ACR procedure, the application context of the terminal device is pulled from the first EAS to the second EAS.

53. The method according to claim 50, further comprising starting using the second connection when the ACR procedure is completed.

54. The method according to claim 50, wherein the first communication module provides a first identifier of the terminal device for the first network, and the second communication module provides a second identifier of the terminal device for the second network.

55. The method according to claim 50, wherein the terminal device is a critical Internet of things (IoT) device.

56. A terminal device, comprising:
one or more processors; and
one or more memories comprising computer program codes,
the one or more memories and the computer program codes configured to, with the one or more processors, cause the terminal device at least to:
detect that a first connection between a first communication module of the terminal device and a first edge application server (EAS) via a first network is broken;
determine to switch from the first connection to a second connection between a second communication module of the terminal device and a second EAS via a second network; and
trigger an application context relocation (ACR) procedure for transferring application context of the terminal device from the first EAS to the second EAS.
